(19) United States
(12) Patent Application Publication
(10) Pub. No.: US 2006/0028457 A1
(43) Pub. Date: Feb. 9, 2006

(54) Stylus-Based Computer Input System

(76) Inventor: David W. Burns, San Jose, CA (US)

Correspondence Address: DAVID W. BURNS, 15770 RICA VISTA WAY, SAN JOSE, CA, 95127, US

(21) Appl. No.: 10/710,854

(22) Filed: Aug. 8, 2004

(51) Int. Cl. G09G 5/00

(52) U.S. Cl. 345/179

(57) ABSTRACT

A system for determining a stylus position of a stylus includes a telemetric imager and a controller electrically coupled to the telemetric imager. The controller determines the stylus position based on a generated image of a stylus tip from a first direction and a generated image of the stylus tip from a second direction when the stylus tip is in a stylus entry region. A method and a system for determining a stylus position are also disclosed.

### BACKGROUND OF THE INVENTION

1. Field of the Invention

This invention relates generally to computer input devices, and more specifically to hardware and software for stylus and mouse input systems.

2. Description of Related Art

A conventional personal computer with a graphical user interface (GUI) environment is equipped with a keyboard and mouse to input data into the computer system, as well as to control cursor movement on a computer screen. Other commercially available peripheral input devices include joysticks, trackballs, pointers, touchscreens, touchpads, and voice input systems. More specialized mouse replacements using foot pedals, head or eye-movement tracking, sip-and-puff controls, and joystick-based head and mouth control systems have been designed for people with limited mobility or muscle control.

Even though various input devices are available, most GUI programming has been standardized to use a mouse or other pointer device that controls the movement of a cursor or other display elements on a computer screen, and that inputs data through click, double-click, drag-and-drop, and other mouse-button functions. Typically, a user controls a cursor by moving a mouse or other electromechanical or electro-optical device over a reference surface, such as a rubber mouse pad, specially marked paper, optical reference pad, or touchscreen so that the cursor moves on the display screen in a direction and a distance that is proportional to the movement of the device.

The use of a standard computer mouse often involves highly repetitive hand and finger movements and positions, and in recent years, has been recognized along with other computer activities as a significant source of occupational injuries in the United States. Repetitive stress disorders are attributable to mouse and other pointing devices, which entail awkward and stressful movements and/or positions for extended periods of time. Computer input devices having configurations that force the wrist, hand, and fingers of the user to assume awkward and stressful positions and/or movements are undesirable.

A conventional mouse design requires the fingers of the user to be splayed out over the mouse housing with the hand in a pronated position, an unnatural position that can strain tendons in the hand. Although some more ergonomic mice have housings with 45- to 90-degree upper surfaces to fit into a less twisted palm, finger tendons still can be strained with the repeated forefinger flexing for mouse button clicking.

Among alternative computer pointing devices that have been designed with ergonomic features is a joystick mouse, which is gripped like a vertical bicycle handle and positions the palm perpendicular to the desktop to allow fingers to curl inwardly. Unfortunately, a joystick, which is manipulated with hand and arm muscles, is better suited to gross motor movement than to fine motions often required in a GUI environment.

Current voice-controlled computer input devices are limited to simple commands that control a computer and cannot efficiently direct cursor movement. U.S. Pat. No. 5,671,158, Fournier et al., discloses a wireless headset with a display and microphone that allows a person to communicate commands and some data input by voice to a nearby computer.

Another type of computer input device that has been developed for limited use is an egg-shaped pointing device that operates wirelessly in an airborne mode, whereby an internal gyroscope detects changes in the position of the mouse. These changes are converted to electrical signals and transmitted by an internal radio-frequency transmitter to a receiver at the computer. While effective for limited GUI manipulations such moving a screen pointer to control projected visual presentations on a wall or computer display, the bulky mouse housing with left and right click mouse buttons is awkward to handle for any extended mouse operations. Often this type of device is used as both a laser pointer and mouse.

With the significant increase of muscular-skeletal problems experienced by computer users, designers of computer peripherals are working to develop more ergonomic mouse alternatives that input digitized data and control a cursor effectively. One solution is a stylus-based input system having a nondigital stylus or writing instrument and a pressure-sensitive writing surface.

Various technologies have been used to determine the position of the stylus, writing instrument or even a finger that is placed on the active writing surface of digitizing tablets, touchscreens, touchpads, and whiteboards. For example, personal computer (PC) tablets may run magnetic pulses through a grid of embedded wires to locate the position of the cursor. Some digital whiteboards employ ultrasonic triangulation and palm-sized PC systems commonly receive data by sensing the touch and movement of a stylus on the screen surface.

A number of touchscreen systems incorporate pressure sensitivity. An exemplary touchscreen system of a PC tablet and cordless pen has 512 levels of pressure, a maximum accuracy of 0.42 mm, and resolution of 3048 lines per inch. The system works with software to annotate directly on word-processed documents and create and verify signatures electronically.

In one type of touchscreen technology, electromagnetic radiation such as visible light or radiowaves is used to determine the position of an object touching the screen. An example of a touchscreen system using electromagnetic radiation is further described in “Calibration of Graphic Data-Acquisition Tracking System,” Zurstadt et al., U.S. Pat. No. 5,583,323 granted Dec. 10, 1996. Another system using surface acoustic waves measures the acoustic waves at the edges of a glass plate and calculates the position on the plate that is selected by a finger or a stylus. Another system uses a stylus that transmits an ultrasound pulse, and then several acoustic sensors on a crossbar triangulate and determine the location of the stylus or finger. A system that emits an IR signal and an acoustic signal from a pen is described in “Transducer Signal Waveshaping System,” Wood et al., U.S. Pat. No. 6,118,205 granted on Sep. 12, 2000.

A second type of touchscreen technology has a homogenous transparent conductor placed over the surface of a display device and a set of bar contacts on the edges of the transparent conductor that charge the conductor. The capacitive coupling of a stylus or a finger to the transparent conductor causes the conductor to discharge while sensors attached to the bar contacts measure the amount of current drawn through each of the contacts. Analysis of the ratios of the currents drawn from pairs of contacts on opposing sides of the rectangle provides an X-Y position on the panel that is selected by the user. An exemplary capacitive touchscreen is taught in “Position Measurement Apparatus for Capacitive Touch Panel System,” Meadows et al., U.S. Pat. No. 4,853,498 granted in Aug. 1, 1989.

A third touchscreen technology uses rectangular uniform resistive material that is mounted on a flat surface and has a series of discrete resistors along the edge. A voltage differential is applied to the row of resistors on opposing sides of the rectangle and in a time-division manner a voltage differential is applied to the row of resistors of the other two opposing sides. The position-indicating signals are either received by a stylus, or by a conductive overlay that can be depressed to contact the surface of the resistive material. One variety of this device is described in U.S. Pat. No. 6,650,319, Hurst et al.

A fourth touchscreen or touchpad technology uses light-receiving and emitting devices to determine the position of a stylus or fingertip. One exemplary system that uses light-receiving and emitting devices to determine the position of a pen or fingertip is taught in “Coordinate Position Inputting/Detecting Device, a Method for Inputting/Detecting the Coordinate Position, and a Display Board System,” Omura et al., U.S. Pat. No. 6,608,619 granted Aug. 19, 2003 and U.S. Pat. No. 6,429,856 granted Aug. 6, 2002. The coordinate position is identified using the distribution of light intensity detected by the light receiving/emitting devices.

A system using optics may have, for example, a digital pen device with a light-emitting diode (LED), at least one switch, a rechargeable battery, and a control circuit, as well as a wired work surface or tablet with an optical receiver. The optical receiver detects the optical output of the LED and transmits positional information to a computer. The pen-like device, which can be used only when in contact with the wired work surface or table, incorporates a pressure-sensitive tip for effecting different saturation levels. A stylus or eraser on a whiteboard may be tracked using an optical scanner, one system being described in “Code-Based, Electromagnetic-Field-Responsive Graphic Data-Acquisition System,” Mallicoat, U.S. Pat. No. 5,623,129 granted Apr. 22, 1997.

In contrast to systems that have direct interactions with the graphical user interface of the computer and are considered mouse replacements, digital writing instruments capture pen strokes on paper or another writing surface and digitize them. In one of these “digital-pen” systems, the pen equipped with an optical sensor acts as miniature scanner. This application of optical sensor technology has had limited success because the scanning digital pen is sensitive to the angle at which it is held. The optical sensor requires that the optical pen be held at a certain angle, and oriented in the same direction during use. Like other specialized pen-based devices with active electrical and optical components, this digital pen tends to be bulky and unbalanced.

Improvements to an optically driven digital pen have been suggested in “Digital Pen Using Speckle Tracking,” Fagin et al., U.S. Patent Application No. 2003/0106985 published Jun. 12, 2003. The digital pen has an ink-writing tip and a laser on a pen body to direct light toward paper across which the writing tip is being stroked. A complementary metal-oxide-semiconductor (CMOS) camera or charge coupled device (CCD) is also mounted on the pen body for detecting reflections of the laser light, referred to as “speckles”, and a processor in the pen body determines relative pen motion based on the speckles. A contact sensor on the pen body senses when the tip is pressed against the paper, with positions being recorded on a flash memory in the pen body when the contact sensor indicates that the pen is against the paper.

One particular method of capturing images of the writing tip uses a probability function for determining the likelihood of whether the pen is touching the paper, as described in “Camera-Based Handwriting Tracking,” Munich et al., U.S. Pat. No. 6,633,671 granted Oct. 14, 2003. The function uses clues including ink on the page and/or shadows.

Another method for optically detecting movement of a pen relative to a writing surface to determine the path of the pen is described in “Apparatus and Method for Tracking Handwriting from Visual Input,” Perona et al., U.S. Pat. No. 6,044,165 granted Mar. 28, 2000. A determination is made either manually, by looking for a predetermined pen tip shape, or by looking for a position of maximum motion in the image. That kernel is tracked from frame to frame to define the path of the writing implement, and correlated to the image: either to the whole image, to a portion of the image near the last position of the kernel, or to a portion of the image predicted by a prediction filter. Limiting the size of area where an image is captured and the resulting amount of image data may help reduce the amount of data transferred and increase the rate of transmission, as suggested in “Handwriting Communication System and Handwriting Input Device Used Therein,” Ogawa, U.S. Pat. No. 6,567,078 granted May 20, 2003.

Optical methods have been used to determine not only the position of a pen or finger on a touchscreen, but also what type of pointing device is being used. One suggested method employs two polarized lights to provide two different images of the pointing device, from which the pointing device can be determined to be a pen or finger, as described in “Optical Digitizer with Function to Recognize Kinds of Pointing Instruments,” Ogawa, U.S. Pat. No. 6,498,602 granted Dec. 24, 2002.

A system and method where triangulation is employed for determining the location of a pointer on a touchscreen is taught in “Diffusion-Assisted Position Location Particularly for Visual Pen Detection,” Dunthorn, U.S. Pat. No. 5,317,140 granted May 31, 1994. Rather than employing focused imaging systems to produce a sharp image at the plane of a photodetector, a deliberately diffuse or blurred image is employed. The position of the maximum intensity, and thus the direction of the object, is determined to a small fraction of the distance between sample points, with an accordingly higher resolution than focused systems.

A second type of digital-pen technology has a digital pen that captures strokes across a writing substrate by sensing the time-dependent position of the pen and converting the positions to digital representations of the pen strokes. In the latter system, digitizing pads, tablets, or screens are used to sense pen or stylus motion.

The position of a digital pen can be detected by various means. Magnetic-type digital pens have been designed to generate or alter a magnetic field as the pen is moved across a piece of paper, with the field being sensed by a special pad over which the paper is placed. Ultrasonic-type digital pen systems use a pen that generates or alters an ultrasonic signal as the pen is moved across a piece of paper, with the signal being sensed by a special pad over which the paper is placed.

Active stylus/pen pointing devices can have mouse-button equivalent input buttons on its body as the primary switch mechanism, requiring a forefinger tap that can strain finger tendons when used repetitively. For example, the design of one wireless pen-computing device includes a so-called paging button on its front face. Unfortunately, such buttons can create awkward and inefficient position for the hands and fingers, which may contribute to discomfort and fatigue of the user during extended use of the device.

One type of Bluetooth™-enabled pen input device uses writing paper with an inked micropattern of coded dots. The paper has a near-invisible grid of gray dots that are each one-tenth of a millimeter in diameter, and arrayed on a slightly displaced grid of 2- by 2-millimeter squares, each square with a unique pattern of 36 dots. The pen contains a transmitter, microprocessor, memory chip, ink cartridge, battery, and a digital camera or optical sensor. As the pen writes over the paper, the camera records the motion via the micropattern on the paper. For example, the camera can take approximately 50 snapshots per second of the paper's dotted pattern and translate the pictures into a set of (x, y) coordinates to describe the current position of the pen. Digital pens of this type can hold 40 to 100 images of pages in its memory for uploading later to a computer. The captured digital information can be transferred later to a computer by syncing the pen via a universal serial bus (USB) cradle or by a wireless technology such as Bluetooth™.

With some digital pen systems, the user checks a specified location on the microcoded paper to indicate that a page is completed, after which the final information is stored on the 1 MB built-in memory chip. Typically, there is a limitation such as 25 pages of notes before this digital pen needs to be recharged. When the pen is placed into its cradle, the information stored on the memory chip is transferred to the connected computer, and the pen is recharged. Digital-pen systems sometimes include handwriting recognition software that converts pen strokes into a digitally stored record of the writing.

One of the disadvantages systems with electronically active digital pens, are that they tend to be quite bulky and may be unbalanced when, for example, the camera is placed near the writing tip of the pen. Thus, these longer pens as a whole are somewhat awkward to use, particularly for extended periods of time. Other limitations may include a limited battery life, requirement for specialized ink cartridges, and the need for specialized and costly writing paper or surface.

While most stylus and touchpad/touchscreen systems do not involve a traditional paper or pen, a few computer input systems are being developed to use conventional pens to write on paper while an electronically active surface simultaneously captures the handwritten images for computer input. One data input system is envisioned as a notebook-sized portfolio having a hand or tablet-sized computer, a paper writing surface for conventional ink, and a digital notepad as described in “Apparatus and Method for Portable Handwriting Capture,” Challa et al., U.S. Pat. No. 6,396,481 granted May 28, 2002. The digital notepad uses electromagnetic, resistivity, or laser-digitizing technology to capture what is written and then transfers the captured image to the small computer. Infrared transceivers of the computer and the notepad are aligned for wireless communication.

Researchers are working on developing more inexpensive and flexible mobile information appliances that tie existing pen and paper activities to computer data entry procedures, simultaneously capturing the data both physically and electronically.

Researchers are also working to extend the functions of digital pens beyond graphics and data entry to mouse-like functions such as cursor control and menu navigation. One proposed pen design has a Bluetooth™-enabled pen with an optical translation measurement sensor placed at the tip of the pen to measure motion relative to the writing surface. The sensor uses a laser source to illuminate the writing surface, which may be almost any flat surface.

One of the primary motivations for developing mouse replacements such as the one just mentioned is the significant increase of carpel tunnel syndrome and other muscular-skeletal problems experienced by those using a computer for many hours. Pointing devices such as a computer mouse can require repetitive hand and finger movements in awkward or stressful positions of the wrist, hand and fingers, which can lead to repetitive stress injuries.

Replacements for the computer mouse should be simple to operate and have accurate positioning capability, while allowing a user to remain in a natural, relaxed position that is comfortable for extended periods of use. A desirable computer input system avoids using bulky or unbalanced input devices, specialized ink cartridges and paper, batteries, and restrictive wiring. An improved mouse replacement maximizes the productivity of the user and makes better use of workspace. An expanded use of a computer input device would provide pen-point accuracy, have an ability to input freeform information such as drawing or handwriting, allow electronic input of handwritten signatures, and have an ability to capture and digitally transfer symbols and alphabet characters not available with a QWERTY keyboard, and functions of a conventional computer mouse.

### SUMMARY OF THE INVENTION

One aspect of the invention provides a system for determining a stylus position of a stylus. The system includes a telemetric imager and a controller electrically coupled to the telemetric imager. The controller determines the stylus position based on a generated image of a stylus tip from a first direction and a generated image of the stylus tip from a second direction when the stylus tip is in a stylus entry region.

Another aspect of the invention is a method of determining a stylus position. A stylus tip of a stylus is positioned in a stylus entry region. An image of the stylus tip from a first direction and an image of the stylus tip from a second direction are generated. The stylus position is determined based on the generated images from the first direction and the second direction when the stylus tip is in the stylus entry region.

Another aspect of the invention is a system for determining a stylus position, including means for positioning a stylus tip of a stylus in a stylus entry region, means for generating an image of the stylus tip from a first direction, means for generating an image of the stylus tip from a second direction, and means for determining the stylus position based on the generated images from the first direction and the second direction when the stylus tip is in the stylus entry region.

Other aspects, features and attendant advantages of the present invention will become more apparent and readily appreciated by the detailed description given below in conjunction with the accompanying drawings. The drawings should not be taken to limit the invention to the specific embodiments, but are for explanation and under-standing. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 illustrates a system for determining a stylus position of a stylus, in accordance with one embodiment of the current invention;

FIG. 2 illustrates a system for determining a stylus position of a stylus, in accordance with another embodiment of the current invention;

FIG. 3 is a block diagram of a system for determining a stylus position, in accordance with another embodiment of the current invention;

FIG. 4 is a flow diagram of a method for determining a stylus position, in accordance with one embodiment of the current invention;

FIG. 5 is a flow diagram of a method for determining a stylus position, in accordance with another embodiment of the current invention;

FIG. 6 is a flow diagram of a method for determining a stylus position, in accordance with another embodiment of the current invention; and

FIG. 7 is a flow diagram of a method for determining a stylus position, in accordance with another embodiment of the current invention.

### DETAILED DESCRIPTION OF THE INVENTION

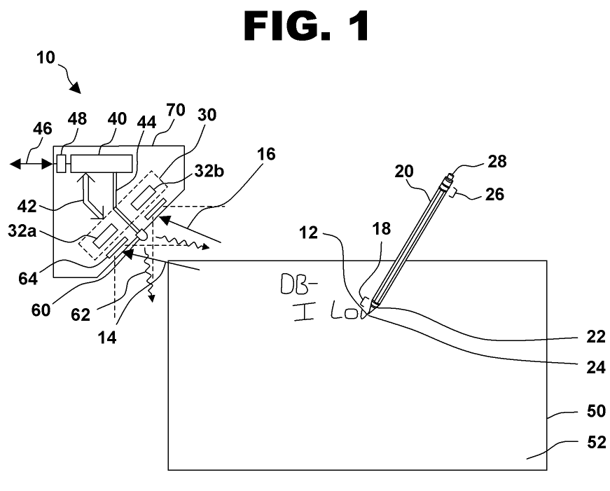

FIG. 1 illustrates a system for determining a stylus position of a stylus, in accordance with one embodiment of the present invention. A system 10, which determines a stylus position 12 of a stylus 20, includes a telemetric imager 30 electrically connected to a controller 40. Controller 40 determines stylus position 12 based on a generated image of a stylus tip 18 of stylus 20 from a first direction 14 and a generated image of stylus tip 18 from a second direction 16 when stylus tip 18 is in a stylus entry region 50. Stylus tip 18 refers herein to one end or the other of stylus 20 along with the region proximate to the cited end. Stylus entry region 50 corresponds to a region where stylus position 12 of stylus 20 is capable of being determined such as, for example, a bounded physical surface and the region above the physical surface. Stylus entry region 50 may be real or virtual. Stylus information output 46 may be sent to a digital computing device through a wired or wireless communication port 48.

Stylus 20 is an instrument such as a pen, pencil, pointer or marker that may be adapted to allow ready recognition by telemetric imager 30. Stylus tip 18 may write on a writable medium 52 positioned in stylus entry region 50 while controller 40 determines stylus position 12. Stylus 20 may be adapted to have a reflective element formed with or fixedly attached to stylus 20 at or near one end or the other. Stylus 20 may include an imaging target such as a writing-mode imaging target 22 near a writing end 24 of stylus 20. Alternatively or additionally, stylus 20 may include an erasing-mode target 26 near an erasing end 28 of stylus 20. Writing-mode imaging target 22 may be coupled to or formed on stylus 20 near writing end 24 of stylus 20 to indicate a writing mode when stylus tip 18 is in stylus entry region 50. Additionally or alternatively, erasing-mode imaging target 26 may be coupled to or otherwise formed on stylus 20 near erasing end 28 of stylus 20 to indicate an erasing mode when stylus tip 18 is in stylus entry region 50. Stylus 20 with erasing end 28 allows erasing of writable medium 52 while controller 40 determines stylus position 12. Imaging targets 22 and 26, such as coded bars, bands or crosses, may include information about the stylus tip angle, stylus tip rotation, stylus type, stylus size, or stylus ink color. Additional features may be added to stylus 20, such as self-illuminative imaging targets 22 and 26, or switches that invoke transmissions to telemetric imager 30 to indicate one or more stylus functions.

Writing end 24 of stylus 20, which can deposit material such as pencil graphite, pen ink, or marker ink when moved over writable medium 52, may be shaped in a round, squared, or chiseled fashion to control the depositing of writing material. For example, Styli 20 can be designed for digital entry of calligraphy with system 10.

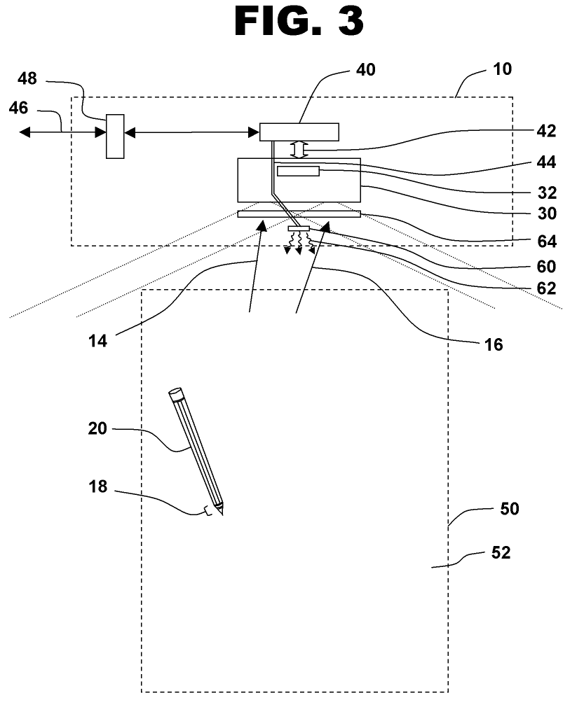

The position of aforementioned stylus 20 may be calculated or otherwise determined by controller 40 using stylus image information 42 generated from telemetric imager 30. Telemetric imager 30 includes, for example, two separated optical imaging arrays 32a and 32b such as complementary metal-oxide-semiconductor (CMOS) imaging arrays or charge-coupled device (CCD) imaging arrays to generate images of stylus tip 18 from first direction 14 and images of stylus tip 18 from second direction 16 when stylus tip 18 is in stylus entry region 50. Alternatively, telemetric imager 30 may include single optical imaging array 32, as illustrated in FIG. 3, to generate images of stylus tip 18 from first direction 14 and images of stylus tip 18 from second direction 16 when stylus tip 18 is in stylus entry region 50 using, for example, a set of binocular optics or another type of optical element (not shown). Other types of optical elements that may help form images on one or more optical imaging arrays 32 include a slit, a pinhole, a lens, a mirror, a curved mirror, a lens array, a mirror array, a prism, a reflective element, a refractive element, a focusing element, or a combination thereof. Optical imaging arrays 32 or 32a and 32b serve as an optical imager for optical images of stylus tip 18 formed thereon and provide stylus image information 42 to controller 40. Controller 40 may run or execute computer program code to determine stylus position 12 and to provide other functions.

A surface of stylus entry region 50 may comprise writable medium 52, such as a sheet or pad of paper. Alternatively, writable medium 52 such as a sheet of paper, a notebook or a notepad may be positionable in stylus entry region 50 on top of a surface of stylus entry region 50.

In one embodiment, a light source 60 is positioned near telemetric imager 30 to illuminate stylus tip 18 with emitted light 62 when stylus tip 18 is in stylus entry region 50. Exemplary light sources 60 such as a light-emitting diode (LED), a laser diode, an infrared (IR) LED, an IR laser, a visible LED, a visible laser, an ultraviolet (UV) LED, a UV laser, a light bulb, or a light-emitting device, may be modulatable or unmodulatable.

In another embodiment, controllable light source 60 is positioned near telemetric imager 30. Light source 60 may be controlled, for example, with a light source control signal 44 generated from controller 40. A first set of images of stylus tip 18 from first direction 14 and second direction 16 is generated with light source 60 turned on to illuminate stylus tip 18 with emitted light 62 from light source 60, and a second set of images of stylus tip 18 from first direction 14 and second direction 16 is generated with light source 60 turned off. A comparison is made between the first set of images and the second set of images to determine stylus position 12. For example, stylus image information 42 from the first set of images is subtracted on a pixel-by-pixel basis to result in a cancellation of stylus image information 42 for objects lit with ambient lighting, while stylus image information 42 from objects such as stylus tip 18 lit with emitted light 62 are emphasized. Stylus tip 18 alone or with imaging targets 22 and 26 positioned near stylus writing end 24 and erasing end 28, respectively, may be readily detected by telemetric imager 30, even with large amounts of ambient lighting on stylus 20. Stylus tip 18 or imaging targets 22 and 26 may be further accentuated using reflective or retroreflective paint or other highly reflective medium.

An optical filter 64 may be positioned between telemetric imager 30 and stylus tip 18 to preferentially pass light 62 from stylus tip 18 to telemetric imager 30. Optical filter 64, for example, preferentially passes light of the same wavelength or set of wavelengths as that of light 62 emitted from light source 60 positioned near telemetric imager 30. Optical filter 64 may have a narrow passband to transmit light 62 in a narrow range of wavelengths while blocking light of other wavelengths to decrease the effects of ambient lighting. Optical filter 64 may be positioned in front of optical imaging array 32, in front of light source 60, or in front of both.

In an exemplary embodiment of the present invention, communication port 48 is connected to controller 40 to enable communication between controller 40 and a digital computing device. Communication port 48 may be a wired or wireless port such as a universal serial bus (USB) port, a Bluetooth™-enabled port, an infrared port, an RJ-11 telephone jack, an RJ-45 fast Ethernet jack, or any other serial or parallel port for built-in WAN, LAN or WiFi wireless or wired connectivity.

A housing 70 may be included with system 10 to contain telemetric imager 30 and controller 40, as well as, for example, a Bluetooth™ microchip that can communicate with other Bluetooth™ device such as a mobile phone or personal digital assistant within proximity to system 10 for determining stylus position 12. Optionally, housing 70 has one or more stylus holders such as a penwell to receive stylus 20 for stylus storage.

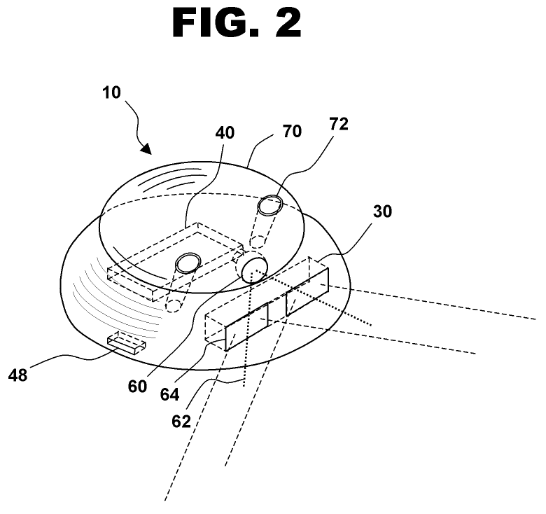

FIG. 2 illustrates a system for determining a stylus position of a stylus, in accordance with another embodiment of the present invention. Like-numbered elements correspond to similar elements in the previous and following figures.

A stylus position determination system 10 includes a housing 70 containing a telemetric imager 30 and a controller 40 to detect and determine the position of a stylus when the stylus is in a stylus entry region. Controller 40 is electrically coupled to telemetric imager 30, and may be included with or separate from telemetric imager 30. Controller 40 determines the stylus position based on a generated image of a stylus tip from a first direction and on a generated image of the stylus tip from a second direction when the stylus tip is in the stylus entry region.

An exemplary configuration of telemetric imager 30 includes one or two optical imaging arrays and associated optics to generate the images of the stylus tip from two directions, allowing for the telemetric determination of the stylus position when the stylus tip is in the stylus entry region.

A light source 60, such as such as an LED, a laser diode, a light bulb or a light-emitting device, may be coupled to housing 70 near telemetric imager 30 to illuminate the stylus tip. Light source 60 may be modulatable or unmodulatable, and controlled to generate images either with light source 60 on or with light source 60 off. When light source 60 is modulated, a comparison can be made between images with light source 60 on and off to determine the stylus position, even with significant amounts of ambient lighting.

In one embodiment of the present invention, one or more optical filters 64 are coupled to housing 70 to preferentially pass light 62 from the stylus tip to telemetric imager 30.

Exemplary system 10 has a communication port 48 such as a wired port or a wireless port that is connected to controller 40 to enable communication between controller 40 and a digital computing device. Housing 70 can provide for and contain hardware associated with wired communication port 48 such as a USB port and take the form of a connectivity stand, pod or cradle. Alternatively, system 10 may be connected to or built into a keyboard, keypad, desktop computer, laptop computer, tablet computer, handheld computer, personal digital assistant, stylus-based computer with or without a keyboard, calculator, touchscreen, touchpad, digitizing pad, whiteboard, cell phone, wireless communication device, smart appliance, electronic gaming device, audio player, video player, or other electronic device.

Optionally, housing 70 has one or more stylus holders 72 for holding and storing a stylus such as a writing instrument. For example, stylus holder 72 may store a pen, pencil, pointer or marker that is not in use.

FIG. 3 is a block diagram of a system for determining a stylus position, in accordance with another embodiment of the present invention. A stylus position determination system 10 determines a position of a stylus 20, for example, when a stylus tip 18 of stylus 20 is in a stylus entry region 50. An image of stylus tip 18 is generated from a first direction 14 and an image of stylus tip 18 is generated from a second direction 16 when stylus tip 18 is in stylus entry region 50. The stylus position may be determined based on the generated images from first direction 14 and second direction 16. A controller 40 running suitable microcode may be used for functions such as determining the stylus position based on the generated images.

System 10 may include a controllable light source 60 for emitting light 62 that can reflect off of a portion of stylus 20, a light detector for detecting reflected light 62 from stylus tip 18 of stylus 20 from a first direction 14 and from second direction 16, and an electronic device for determining the stylus position based on detected light 62 from first direction 14 and second direction 16. System 10 may include an electronic device (not shown) to turn off controllable light source 60, a light detector to detect reflected ambient light from first direction 14 and second direction 16, and a digital computing device for determining the stylus position based on differences between detected light 62 from first direction 14 and second direction 16 when light source 60 is on, and detected light 62 from first direction 14 and second direction 16 when light source 60 is off.

Stylus 20 such as a pen, pencil, pointer or marker is positioned in stylus entry region 50, for example, with a human hand gripping stylus 20 near a writing end or an erasing end. A writing mode or an erasing mode may be indicated, for example, with a writing-mode imaging target positioned near a writing end of stylus 20 and an erasing-mode imaging target positioned near an erasing end of stylus 20. Stylus 20 may be used for writing or erasing while the position of stylus 20 is determined. Stylus entry region 50 may enclose, for example, a non-writable surface area such as a mouse pad, or a writable surface such as a sheet of paper or a pad of paper. At the preference of a user, a writable medium 52 such as a sheet of paper, a notebook or a notepad can be positioned in stylus entry region 50 and then written upon, during which time a relay of information on the changing stylus positions is being entered into system 10 and any externally connected digital computing device.

Stylus tip 18 is detected when positioned in stylus entry region 50, such as when stylus tip 18 is in contact with a surface corresponding to stylus entry region 50. Images of stylus tip 18 may be generated from two different directions, for example, with one or two optical imaging arrays 32 such as CMOS or CCD imaging arrays and associated binocular or telemetric optics in a telemetric imager 30. Determination of stylus position may be made, for example, with controller 40 running code to capture output from optical imaging arrays 32 and to compute the x, y and z location of stylus tip 18 from telemetric formulas, pattern-recognition techniques, or a suitable model based on the stylus image information 42. Controller 40 may be part of or separate from telemetric imager 30.

Stylus tip 18 may be illuminated, for example, with light source 60 such as a LED, a laser diode, a light bulb, or a light-emitting device mounted near one or more optical imaging arrays 32 to illuminate stylus tip 18. For example, a light source control signal 44 can turn on light source 60 to illuminate stylus tip 18 while generating a first set of images from two directions 14 and 16, and then turn off light source 60 while generating a second set of images from two directions 14 and 16. Data from the two sets of images may be compared, for example, by subtracting the digital output of one from the other, and determining the stylus position based on the differences. An optical filter 64 may be used to filter out the majority of ambient lighting while passing through to telemetric imager 30 light 62 that is emitted from light source 60 and reflected off of at least a portion of stylus 20.

Pattern recognition or formulation techniques may be used, for example, to determine whether stylus 20 is in a writing mode or an erasing mode when stylus tip 18 is in stylus entry region 50. For example, a writing-mode imaging target placed near a writing end of stylus 20 may be used to indicate stylus position and writing-mode operation. Similarly, an erasing-mode imaging target placed near an erasing end of stylus 20 may be used to indicate stylus position and erasing-mode operation. Pattern recognition may be used, for example, to recognize a predetermined tip shape or to locate and interpret a predetermined target on stylus 20.

The angle of stylus 20 with respect to stylus entry region 50 may be determined, for example, with the aid of stylus-angle imaging targets when stylus tip 18 is in stylus entry region 50. Similarly, an angle of stylus rotation may be determined, for example, with the aid of stylus-rotation imaging targets. For example, determining the angle and rotation of stylus 20 is particularly beneficial to styli 20 that are used for calligraphy. Exemplary stylus tip 18 of stylus 20 may write on conventional writable medium 52 such as a sheet of paper when stylus tip 18 is on writable medium 52 in stylus entry region 50. Stylus 20 can be similar to a conventional pen, pencil or marker, or a pen, pencil or marker that is adapted to improve position determination capability.

When stylus tip 18 is in stylus entry region 50, stylus information output 46 such as x, y and z coordinates, scaled x, y and z coordinates, or x and y coordinates may be sent with a wired or wireless connection to a digital computing device such as a laptop, personal digital assistant (PDA), cell phone, electronic gaming device, tablet PC, stylus-based computer with or without a keyboard, personal computer (PC), smart appliance, or other electronic device using standard connection and communication protocols. A wired or wireless communication port 48 may be used to enable communications between system 10 and a digital computing device connected to system 10.

Stylus information output 46 may be interpreted, for example, with a software application running in controller 40 of system 10 or in a digital computing device connected to system 10. Interpretations of stylus position include but are not limited to a distance determination between stylus tip 18 and a surface in stylus entry region 50, a determination of whether stylus tip 18 is in contact with a surface in stylus entry region 50, a determination of a writing mode or an erasing mode, handwriting input information, drawing input information, mouse functions such as clicks and double-clicks, selection functions, soft-key selections, drag-and-drop functions, scrolling functions, stylus stroke functions, and other functions of computer input devices. Stylus information output 46 is interpreted as, for example, writing input information, drawing input information, pointer input information, selection input information, or mouse input information.

In another embodiment, system 10 includes two or more light sources 60 that are positioned near telemetric imager 30. Light sources 60 are spatially separated and turned on in a suitable sequence. Light 62 reflected from imaging targets of stylus 20 appears to emanate from a slightly different angle or point, allowing telemetric imager 30 with one or two optical imaging arrays 32 to provide stylus image information 42 that can be used to determine the position of stylus 20. In a first example, two horizontally separated light sources 60 are sequentially flashed. Stylus images formed on optical imaging array 32 with reflected light 62 from a cylindrically disposed imaging target are processed to determine the position of stylus tip 18. The stylus position may be determined with a pair of optical imaging arrays 32 and an associated pair of imaging optics or with a single optical imaging array 32 and a single set of imaging optics. In a second example, two vertically separated light sources 60 are sequentially flashed. Stylus images formed on one or more optical imaging arrays 32 are processed to determine the stylus position. In a third example, a triad or quad array of light sources 60 is configured and sequenced to provide stylus image information 42 from which the stylus position is determined. In a fourth example, two or more spatially separated light sources 60 are lit in sequence to wobble sequential images off of a curved imaging target on stylus 20, and then the images are compared or subtracted to determine the stylus position.

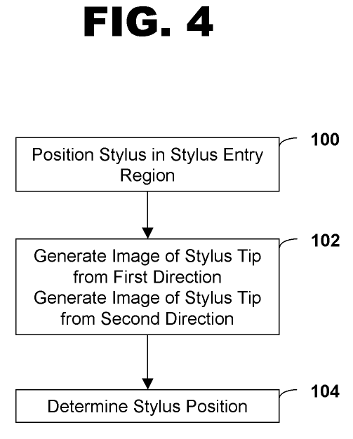

FIG. 4 is a flow diagram of a method for determining a stylus position, in accordance with one embodiment of the present invention.

A stylus tip of a stylus is positioned in a stylus entry region, as seen at block 100. The stylus, such as a pen, pencil, pointer, marker, or a writing, marking or pointing instrument adapted thereto, includes a stylus tip. The stylus tip may be positioned in the stylus entry region, where contact can be made with a surface associated with the stylus entry region.

An image of the stylus tip from a first direction and an image of the stylus tip from a second direction are generated, as seen at block 102. Images of the stylus tip from two directions allow the triangulation and determination of the position of the stylus tip when the stylus tip is in the stylus entry region. In one example, the image of the stylus tip from the first direction is generated with a first optical imaging array and the image of the stylus tip from the second direction is generated with a second optical imaging array. In another example, the image of the stylus tip from the first direction and the image of the stylus tip from the second direction are generated with one optical imaging array.

The stylus position is determined based on the generated images from the first direction and the second direction, as seen at block 104. The stylus position is determined, for example, with pattern-recognition algorithms that determine the position of the stylus tip and whether the stylus tip is in contact with the surface corresponding to the stylus entry region. Alternatively, the stylus position may be determined using telemetric formulas or other suitable stylus position determination algorithm.

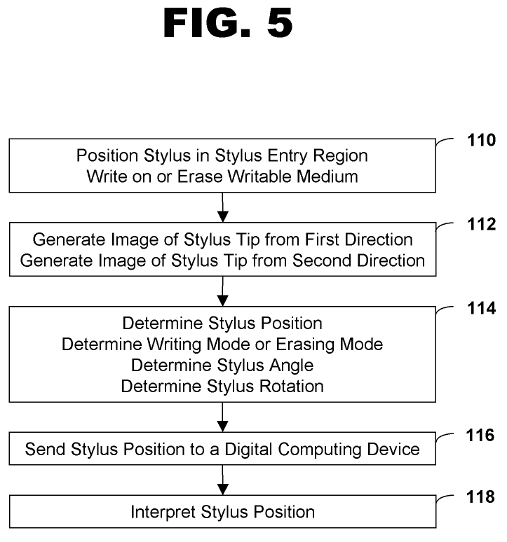

FIG. 5 is a flow diagram of a method for determining a stylus position, in accordance with another embodiment of the present invention.

A stylus tip of a stylus is positioned in a stylus entry region, as seen at block 110. When in the stylus entry region, the stylus tip may write on a writable medium such as a sheet or pad of paper positioned in the stylus entry region. Alternatively, the writable medium may form a surface of the stylus entry region.

Images of stylus tip from a first direction and from a second direction are generated, as seen at block 112. A CMOS or CCD imaging array may be used, for example, to generate the images.

The stylus position is determined based on the generated images from the first direction and the second direction when the stylus tip is in the stylus entry region, as seen at block 114. The image of the stylus tip from the first direction may be generated with a first optical imaging array and the image of the stylus tip from the second direction may be generated with a second optical imaging array. Alternatively, the image of the stylus tip from the first direction and the image of the stylus tip from the second direction are generated with one optical imaging array. The stylus position may be determined using, for example, telemetric formulations or pattern recognition techniques to ascertain the coordinate location of the stylus tip and the distance that the stylus tip is from the surface associated with the stylus entry region. A writing mode or an erasing mode can be determined when the stylus tip is in the stylus entry region. The stylus angle may be determined. The stylus rotation may also be determined when the stylus tip is in the stylus entry region. For example, imaging targets affixed near one end or the other of the stylus are coded or otherwise differentiable to enable determination of a writing or an erasing mode, stylus tip-angle information, or stylus tip-rotation information in addition to stylus position.

The stylus position such as absolute or relative stylus coordinate data is sent to a digital computing device, as seen at block 116. The stylus position may be sent by a wired or a wireless connection to a digital computing device such as a laptop computer, cell phone, personal digital assistant, electronic gaming device, tablet PC, stylus-based computer with or without a keyboard, desktop personal computer, smart appliance, or other electronic device. For example, the stylus may be used to input and erase information for a two-dimensional (2D) or three-dimensional (3D) crossword puzzle game or a 2D or 3D Scrabble® game on an interactive screen.

The stylus position is interpreted, as seen at block 118. Handwriting information, script information, drawing information, selection information, pointer functions, mouse functions, writing-mode functions, erasing-mode functions, stylus stroke functions and input from predefined stylus movements may be interpreted using suitable software applications running locally or externally in a connected digital computing device. Applications such as word-processing programs, spreadsheets, Internet programs or games running on the connected digital computing device may respond to the stylus coordinate data and the stylus stroke functions. For example, a file generated using Microsoft® Word, PowerPoint®, Excel, Internet Explorer, or Outlook® from Microsoft Corporation, a .pdf file generated using Adobe® Acrobat®, a computer-aided design file generated using AutoCAD® from Autodesk®, a 3D CAD file generated using SolidWorks® from SolidWorks Corporation or a Nintendo® electronic game may be updated or responded to based on stylus input information.

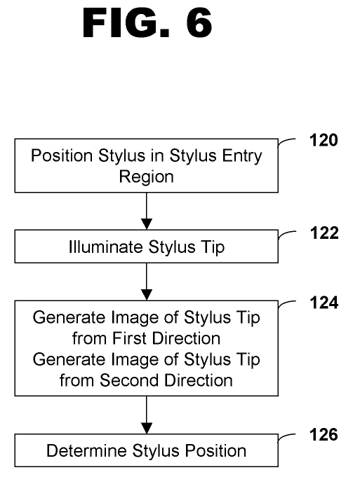

FIG. 6 is a flow diagram of a method for determining a stylus position, in accordance with another embodiment of the present invention. A stylus tip of a stylus is positioned in a stylus entry region, as seen at block 120. The stylus tip is illuminated with a light source when the stylus tip is in the stylus entry region, as seen at block 122. An image of the stylus tip from a first direction and an image of the stylus tip from a second direction are generated, as seen at block 124. The images may be generated, for example, using one or two optical imaging arrays and associated optics. The stylus position is determined based on the generated images from the first direction and the second direction when the stylus tip is in the stylus entry region, as seen at block 126.

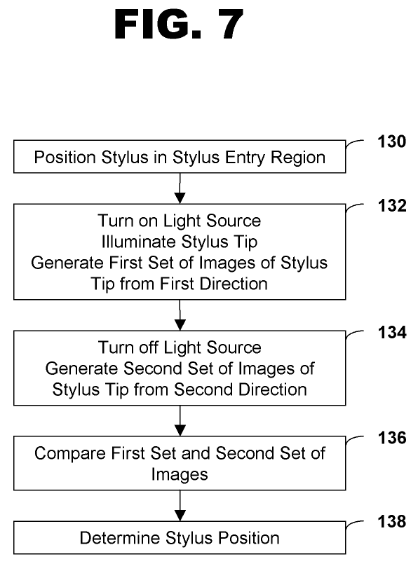

FIG. 7 is a flow diagram of a method for determining a stylus position, in accordance with another embodiment of the present invention. A stylus tip of a stylus is positioned in a stylus entry region, as seen at block 130. A controllable light source is switched on to illuminate the stylus tip, as seen at block 132. A first set of images of the stylus tip from a first direction and from a second direction is generated, for example, with one or two optical imaging arrays and associated optics. The light source is switched off, and a second set of images of the stylus tip from the first direction and from the second direction is generated, as seen at block 134. The first set of generated images is compared with the second set of generated images, as seen at block 136. The stylus position is determined based on the comparison, as seen at block 138.

While the embodiments of the invention disclosed herein are presently considered to be preferred, various changes and modifications can be made without departing from the spirit and scope of the invention. For example, while the embodiments of the invention are presented as communicating with a desktop personal computer, the invention can work with a cellular phone, personal digital assistant, electronic gaming device, tablet PC, stylus-based computer with or without a keyboard, smart appliance, other devices having a digital signal processor and GUI interface, or other electronic device. The scope of the invention is indicated in the appended claims, and all changes that come within the meaning and range of equivalents are embraced herein.

1. A system for determining a stylus position of a stylus, the system comprising:
a telemetric imager; and
a controller electrically coupled to the telemetric imager;
wherein the controller determines the stylus position based on a generated image of a stylus tip from a first direction and a generated image of the stylus tip from a second direction when the stylus tip is in a stylus entry region.

2. The system of claim 1, wherein the stylus comprises one of a pen, a pencil, a pointer, or a marker.

3. The system of claim 1, wherein the stylus tip allows writing on a writable medium while the controller determines the stylus position.

4. The system of claim 1, wherein the stylus includes a writing-mode imaging target near a writing end of the stylus.

5. The system of claim 1, wherein the stylus includes an erasing-mode imaging target near an erasing end of the stylus.

6. The system of claim 1, wherein the telemetric imager comprises two optical imaging arrays to generate the image of the stylus tip from the first direction and the image of the stylus tip from the second direction when the stylus tip is in the stylus entry region.

7. The system of claim 1, wherein the telemetric imager comprises one optical imaging array to generate the image of the stylus tip from the first direction and the image of the stylus tip from the second direction when the stylus tip is in the stylus entry region.

8. The system of claim 1, wherein the stylus entry region comprises a writable medium.

9. The system of claim 8, wherein the writable medium comprises one of a sheet of paper or a pad of paper.

10. The system of claim 1 further comprising:
a writable medium positionable in the stylus entry region.

11. The system of claim 1 further comprising:
a light source positioned near the telemetric imager;
wherein light emitted from the light source illuminates the stylus tip when the stylus tip is in the stylus entry region.

12. The system of claim 11, wherein the light source is one of a modulatable light source or an unmodulatable light source.

13. The system of claim 11, wherein the light source is selected from the group consisting of a light-emitting diode, a laser diode, an infrared light-emitting diode, an infrared laser, a visible laser, an ultraviolet light-emitting diode, an ultraviolet laser, a light bulb, and a light-emitting device.

14. The system of claim 1 further comprising:
a controllable light source positioned near the telemetric imager;
wherein a first set of images of the stylus tip from the first direction and the second direction are generated with the light source on, and wherein a second set of images of the stylus tip from the first direction and the second direction are generated with the light source off; and
wherein the first set of images and the second set of images are compared to determine the stylus position.

15. The system of claim 1 further comprising:
an optical filter positioned between the telemetric imager and the stylus tip;
wherein the optical filter preferentially passes light from the stylus tip to the telemetric imager.

16. The system of claim 1 further comprising:
a communication port connected to the controller to enable communication between the controller and a digital computing device.

17. The system of claim 16, wherein the communication port is one of a wired port or a wireless port.

18. The system of claim 1 further comprising:
a housing;
wherein the telemetric imager and the controller are contained in the housing.

19. The system of claim 18 further comprising:
at least one stylus holder formed within the housing;
wherein the stylus holder receives the stylus for stylus storage.

20. A method of determining a stylus position, the method comprising:
positioning a stylus tip of a stylus in a stylus entry region;
generating an image of the stylus tip from a first direction;
generating an image of the stylus tip from a second direction; and
determining the stylus position based on the generated images from the first direction and the second direction when the stylus tip is in the stylus entry region.

21. The method of claim 20, wherein the image of the stylus tip from the first direction is generated with a first optical imaging array and the image of the stylus tip from the second direction is generated with a second optical imaging array.

22. The method of claim 20, wherein the image of the stylus tip from the first direction and the image of the stylus tip from the second direction are generated with one optical imaging array.

23. The method of claim 20 further comprising:
illuminating the stylus tip with a light source when the stylus tip is in the stylus entry region.

24. The method of claim 20 further comprising:
turning on a light source to illuminate the stylus tip;
generating a first set of images of the stylus tip from the first direction and from the second direction;
turning off the light source;
generating a second set of images of the stylus tip from the first direction and from the second direction;
comparing the first set of generated images with the second set of generated images; and
determining the stylus position based on the comparison.

25. The method of claim 20 further comprising:
determining one of a writing mode or an erasing mode when the stylus tip is in the stylus entry region.

26. The method of claim 20 further comprising:
determining a stylus angle of the stylus when the stylus tip is in the stylus entry region.

27. The method of claim 20 further comprising:
determining a stylus rotation of the stylus when the stylus tip is in the stylus entry region.

28. The method of claim 20 further comprising:
writing on a writable medium with the stylus tip when the stylus tip is in the stylus entry region.

29. The method of claim 20 further comprising:
sending the determined stylus position to a digital computing device.

30. The method of claim 20 further comprising:
interpreting the determined stylus position.

31. A system for determining a stylus position, the system comprising:
means for positioning a stylus tip of a stylus in a stylus entry region;
means for generating an image of the stylus tip from a first direction;
means for generating an image of the stylus tip from a second direction; and
means for determining the stylus position based on the generated images from the first direction and the second direction when the stylus tip is in the stylus entry region.

32. The system of claim 31 further comprising: means for illuminating the stylus tip with a light source when the stylus tip is in the stylus entry region.

33. The system of claim 31 further comprising:
means for turning on a light source to illuminate the stylus tip;
means for generating a first set of images of the stylus tip from the first direction and from the second direction;
means for turning off the light source;
means for generating a second set of images of the stylus tip from the first direction and from the second direction;
means for comparing the first set of generated images with the second set of generated images; and
means for determining the stylus position based on the comparison.

34. The system of claim 31 further comprising:
means for determining one of a writing mode or an erasing mode when the stylus tip is in the stylus entry region.

35. The system of claim 31 further comprising:
means for determining a stylus angle of the stylus when the stylus tip is in the stylus entry region.

36. The system of claim 31 further comprising:
means for determining a stylus rotation of the stylus when the stylus tip is in the stylus entry region.

37. The system of claim 31 further comprising:
means for writing on a writable medium with the stylus tip when the stylus tip is in the stylus entry region.

38. The system of claim 31 further comprising:
means for sending the determined stylus position to a digital computing device.

39. The system of claim 31 further comprising:
means for interpreting the determined stylus position.
